(19) United States
(12) Patent Application Publication
(10) Pub. No.: US 2012/0178605 A1
(43) Pub. Date: Jul. 12, 2012

(54) CUTTING AND GROOVING DEVICE AS WELL AS METHOD FOR CUTTING AND/OR GROOVING

(76) Inventors: Sebastian SPÖRKE, Burkersdorf (DE); Marcel BEYER, Hilbersdorf (DE)

(21) Appl. No.: 13/344,933

(22) Filed: Jan. 6, 2012

(30) Foreign Application Priority Data
Jan. 7, 2011 (EP) 11 150 372.8

(51) Int. Cl. B31B 1/14

(52) U.S. Cl. 493/370

(57) ABSTRACT

The present invention relates to a cutting and grooving device (10), in particular for cardboard boxes, having two round grooving tool halves (12; 14) and a cutting device (16) disposed between the two grooving tool halves (12; 14), whereby the cutting device is movable between a non-operative position radially inside between the grooving tool halves (12; 14) and an operative position radially outside the grooving tool halves (12; 14).

It is possible with the cutting and grooving device (10) both to groove and also to cut workpieces (11).

(FIG. 1)

### TECHNICAL FIELD

The present invention relates to a cutting and grooving device as well as a method for cutting and/or grooving. Such devices and/or methods are used, for example in the packaging industry during the production of foldable cardboard boxes and cardboard packages to provide them with a groove or also with a channel along which the cardboard can subsequently be folded. In addition, it is desirable with such devices and/or methods that a cut can also be introduced into the cardboard such that desired carton formats, in particular during production using lot size 1, can be manufactured without major retooling times.

### PRIOR ART

WO 2006/091149 A1 describes a cutting and grooving arrangement by means of which it is possible to carry out both a cutting and also a grooving procedure on a workpiece to be processed. This cutting and grooving arrangement is constructed such that two grooving wheel halves are provided with the identical radial diameter and a cutting tool arranged between them. By arranging the cutter between the grooving wheels, it is possible when cutting with the cutter to compress the workpiece additionally by means of the grooving wheels such that it is possible to execute the cutter with a smaller diameter.

This cutting and grooving arrangement, however, has the disadvantage that at high processing speeds, the compression rate with which the workpiece is compressed during grooving is very high, which not only leads to the workpiece being grooved but also to tearing of the workpiece, in particular of the cardboard. This is frequently observed above all in the case of thick corrugated cardboards.

### Presentation of the Invention

Thus the object of the invention is to create a cutting and grooving device and a method for cutting and/or grooving which solves the known problems arising from the prior art and is further suitable to enable safe and reliable grooving or compression of the workpiece at high processing speeds.

The object is achieved by the subject-matter of claim 1. Preferred developments emerge from the subclaims.

The invention is based on the idea of using the grooving tool halves of a cutting and grooving device in such a skilled manner that the compression rate can be adjusted optimally to the workpiece despite a high processing speed during grooving.

Hence, the cutting and grooving device according to the invention, in particular for cardboard boxes, comprises two round, in particular circular, grooving tool halves and a cutting device arranged between the two grooving tool halves, whereby the cutting device is movable between a non-operative position radially inside between the grooving tool halves and an operative position radially outside the grooving tool halves. In this case the two grooving tool halves each have diameters of different sizes.

A grooving tool half within the meaning of the invention is in this case any type of tool that is suitable for grooving of cardboard boxes or the like. In this case, the grooving tool halves are round, in particular circular, and have a surface on their circumference that is formed such that grooving of the cardboard box can be carried out advantageously. Round and to some extent also flat cross-sections are suitable for this.

With the cutting and grooving device according to the invention, it is conditionally possible due to the fact that the two grooving tool halves have different diameters to compress the workpiece to be processed gently during grooving and/or cutting as the grooving tool half with the larger diameter can be used advantageously so that it initially starts to compress the workpiece and subsequently the grooving tool half with the smaller diameter assists the grooving tool half with the larger diameter with complete compression. On one hand, a high processing speed of the cutting and grooving device can be implemented in this way and on the other the compression rate when grooving can be reduced in such a way that damaging, in particular tearing, of the material, in particular the cardboard or corrugated cardboard, can be prevented. Therefore it is possible to considerably reduce the proportion of waste during production which means that production costs can be reduced.

According to one embodiment, the two grooving tool halves with different diameters are arranged such that at least in one section of the area to be processed the distance between the two grooving tool halves and a workpiece to be processed is identical. In this way it is possible to advantageously create an area to be processed in that the workpiece is compressed by means of both grooving tool halves in such a way that reliable and adequate grooving of the workpiece is enabled.

According to another especially preferred embodiment, the difference in the diameter of the two grooving tool halves is between 5 and 40%, preferably between 10 and 20%, especially preferably approx. 15%. Tearing or similar of the workpiece can be prevented particularly reliably with a difference in diameter of the grooving tool halves within this range, such that particularly reliable and good grooving is enabled.

According to another especially preferred embodiment of the invention, the two grooving tool halves are arranged such that the grooving tool half with the larger diameter initiates a grooving process first. In this way it is possible due to the larger diameter and due to grooving initially performed with only one grooving tool half to influence the compression rate during grooving so advantageously that tearing of the workpiece or similar is prevented.

The device according to the invention may, according to another advantageous embodiment, have a cutting device with an essentially circular cutter and/or a cutting device which is a perforating cutting device. Alternative cutting devices are also conceivable.

According to another especially preferred embodiment, the invention relates to a method for cutting and/or grooving of workpieces, in which the grooving tool half with the larger diameter initially begins to compress or groove the workpiece and subsequently both grooving tool halves compress the workpiece.

In this way it is especially advantageously possible to compress the workpiece gently since the grooving wheel halves initiate the compression one after another.

### BRIEF DESCRIPTION OF THE DRAWINGS

FIG. 1 shows a perspective view of a cutting and grooving device,

FIG. 2 shows a first lateral view of the cutting device,

FIG. 3 shows a cutting device rotated by 90° relative to FIG. 2 and

FIG. 4 shows a lateral view of a grooving and cutting device with extended cutting device.

### DETAILED DESCRIPTION OF A PREFERRED EMBODIMENT OF THE INVENTION

A cutting and grooving device 10 according to the invention is described in the following by way of example based on an exemplary embodiment. Cutting and grooving device 10 is preferably used when processing cardboard, cardboard boxes, paperboard, corrugated cardboard and the like.

Cutting and grooving device 10 is used in this case for cutting and grooving workpieces 11, whereby grooving describes a process in which a channel is introduced into workpiece 11 by applying pressure to the same in order to generate a “groove”. The workpiece is subsequently easier to fold or crease along this groove.

Cutting and grooving device 10 has two essentially round grooving tool halves 12 and 14 for this purpose. Grooving tool halves 12 and 14 are arranged next to each other in the axial direction in such a way that a cutting device 16 (this will be described further down) can be disposed between them.

When grooving a workpiece 11 to be processed using cutting and grooving device 10, said cutting and grooving device 10 is pressed onto the area of workpiece 11 to be grooved and subsequently a relative movement in the grooving direction is effected between workpiece 11 and cutting and grooving device 10. In this case, workpiece 11 can be moved relative to cutting and grooving device 10 and cutting and grooving device 10 can also be moved relative to the workpiece.

The (driven) movement of two grooving tool halves 12, 14 is guided by rollers 20 at least partly attached to roller supports 18.

Both grooving tool halves 12, 14 have a different diameter, whereby the different diameter may be between 5-40%, preferably 10-20%, especially preferably 15%. Due to this difference in diameter, it is possible when grooving workpiece 11 to prevent the compression rate during grooving from being too great at high processing speed such that workpiece 11 is prevented from tearing during grooving. Both grooving tool halves 12, 14 are arranged in this case such that both halves 12, 14 rest flat on workpiece 11 in a small section at least. In other words, grooving tool half 12 with the larger diameter therefore initially carries out a first compression process which in due course is supported by smaller grooving tool half 14 until both grooving tool halves rest on the workpiece at the point of maximum compression. FIG. 2 illustrates this relationship.

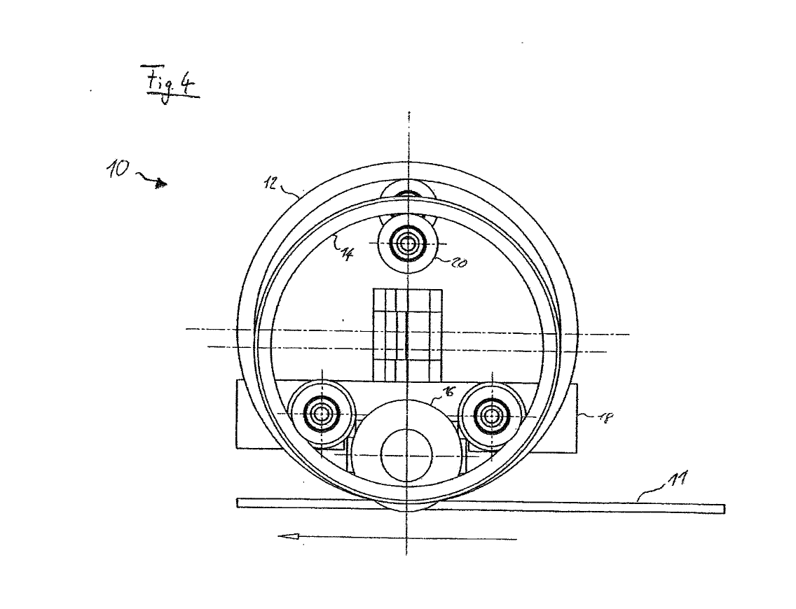

As can be seen in FIG. 3, both grooving tool halves 12, 14 are appropriately shaped in cross-section so as to create a suitable geometry of the groove line. Other shapes are also conceivable.

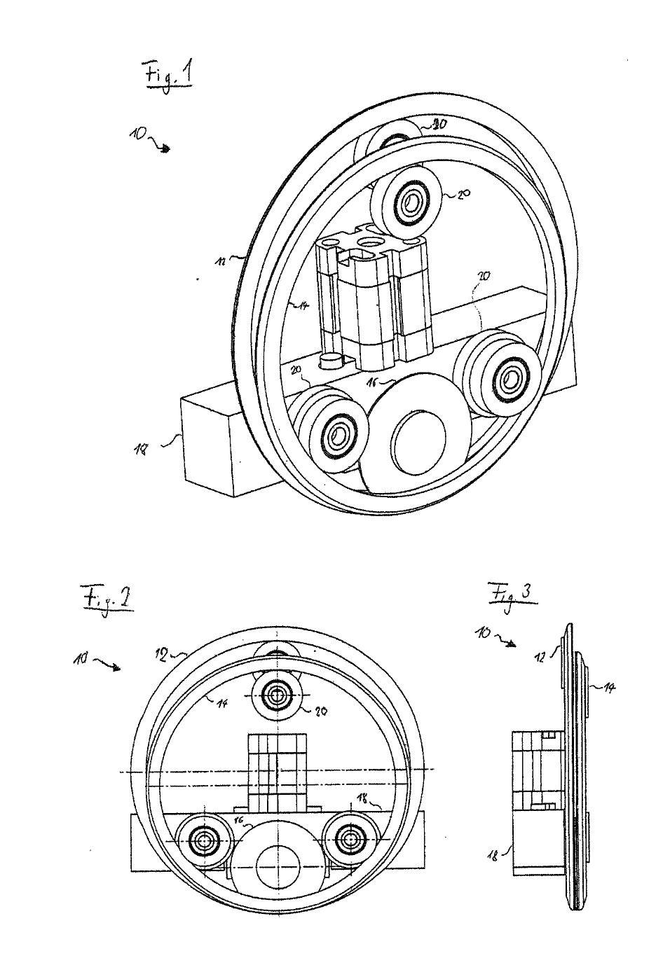

Moreover, it is additionally possible using cutting and grooving device 10 according to the invention to introduce a cut into workpiece 11 using cutting device 16. In this case, cutting device 16 is configured such that it can be moved between a retracted position (see FIG. 1-3) and an extended position (see FIG. 4). When cutting, the cutting device can additionally cooperate with both grooving tool halves 12, 14 in that both grooving tool halves 12, 14 additionally compress workpiece 11 during cutting such that a reduced cutting depth is required. Moving of cutting device 16 between the operative position, in which it carries out a cutting process of workpiece 11, and the non-operative position (see FIG. 1-3), in which no cutting process is carried out, may be carried out using an appropriate actuator or also manually.

Cutting device 16 may be executed both as a cutting device which completely cuts through the workpiece and also as a perforating cutting device which only partially cuts through the workpiece. In this way, it is possible to only partially cut into the workpiece, in particular the cardboard boxes and the like, and subsequently to process them further.

1. A cutting and grooving device (10), in particular for cardboard boxes, comprising:
two round grooving tool halves (12; 14) and
a cutting device (16) disposed between the two grooving tool halves (12; 14),
whereby the cutting device (16) is movable between a non-operative position radially inside between the grooving tool halves (12; 14) and an operative position radially outside the grooving tool halves (12; 14),
characterized in that
the two grooving tool halves (12; 14) have different diameters.

2. The cutting and grooving device according to claim 1, characterized in that the two grooving tool halves (12; 14) are arranged such that at least in one section of the area to be processed the distance between the two grooving tool halves (12; 14) and a workpiece (11) to be processed is identical.

3. The cutting and grooving tool device according to claim 1 or 2, characterized in that the difference in the diameter of the two grooving tool halves (12; 14) is between 5 and 40%, preferably between 10 and 20%, especially preferably approx. 15%.

4. The cutting and grooving device according to one of the preceding claims, characterized in that the grooving tool halves (12; 14) are arranged such that the grooving tool half (12) with the larger diameter initiates a grooving process first.

5. The cutting and grooving device according to one of claims 1-4, characterized in that the cutting device (16) has an essentially circular cutter.

6. The cutting and grooving device according to one of claims 1-4, characterized in that the cutting device (16) is a perforating cutting device.

7. A method for cutting and/or grooving of workpieces using a cutting and grooving device according to one of claims 1-6, characterized in that when grooving the grooving tool half (12) with the larger diameter initially begins to compress the workpiece and subsequently both grooving tool halves (12; 14) compress the workpiece (11).
